(19) United States
(12) Patent Application Publication
(10) Pub. No.: US 2022/0297784 A1
(43) Pub. Date: Sep. 22, 2022

(54) VEHICLE PROVIDED WITH A STEERING TRANSMISSION SYSTEM BASED IN BOWDEN CABLES OR HYDRAULIC SYSTEM

(71) Applicant: LAMPSY PERSONAL MOBILITY, S.L., Barcelona (ES)

(72) Inventor: José Luis PÉREZ BAEZA, Barcelona (ES)

(21) Appl. No.: 17/639,407

(22) PCT Filed: Feb. 6, 2020
(86) PCT No.: PCT/EP2020/053031

§ 371 Date: Mar. 1, 2022

(30) Foreign Application Priority Data
Sep. 6, 2019 (EP) 19382774.8

(51) Int. Cl. B62K 3/00; B62K 21/02; B62K 21/12; B62K 21/18

(52) U.S. Cl. CPC B62K 3/002; B62K 21/02; B62K 21/12; B62K 21/18; B62K 2204/00; B62K 2202/00

(57) ABSTRACT

A vehicle includes a front wheel, a support of the front wheel, a steering handlebar, a platform and a front part joined to the platform. The support is rotatably mounted on the front part, and includes a driven rotating part, the handlebar having a driving rotating part. The driven rotating part and the driving rotating part are connected by Bowden Cables or hydraulic tubes. An impact absorber for a scooter is provided with a support of the front wheel formed by at least a leaf spring including a front end destined to bear the support of the front wheel, an opening adjacent to the front end destined to allow the passage of an upper prolongation of the scooter platform, and a rear end provided with two arms destined to support the rear wheel, such that the impact absorber constitutes the suspension of both the front wheel and the rear wheel.

### TECHNICAL FIELD

The present disclosure relates to a vehicle where the connection between the handle bar and the support of the front wheel is implemented with Bowden cables or hydraulic tubes, such that a steering rod can be dispensed of.

The disclosure also relates to an impact absorber for both the front and the rear wheel of a scooter.

The present disclosure also relates to a scooter, preferably an electric scooter, provided with suspension means that implies a simpler arrangement, more steering possibilities, specially more reduced steering components. The disclosure can also be applied to a mechanical scooter or to a tricycle having only one front wheel.

### BACKGROUND

Known are in the art scooters comprising a user support platform, a front wheel and a support of the front wheel. For example, DE9403582U1 discloses a collapsible scooter having a footboard and a steering column. The footboard is arranged on two tubes running parallel to each other. The steering column is connected to a support member for the front wheel of the scooter. Furthermore, the steering column is rotatably connected to the footboard by means of a steering head. In addition, the scooter comprises a rod rotatably connected to the axis of the front wheel and to the two tubes. The rotatable connections render the scooter collapsible, decreasing the amount of space required when storing the scooter. However, the suspension of the scooter can be further improved.

U.S. Pat. No. 5,127,488A discloses a power accessory that can be retrofitted to a skateboard. The power accessory comprises a drive assembly comprising a combustion engine which powers a drive wheel. The skater can control the power supplied to the drive wheel by means of a hand grip. The hand grip is connected to the drive assembly through a cable. The drive assembly is attached to the skateboard by means of a leaf spring. In particular, the drive assembly is mounted on one end of the leaf spring and the other end of the leaf spring is attached between the rear truck and the body of the skateboard. The leaf spring has a slight offset in it so that when the leaf spring is connected to the body of the skateboard, the rear wheel of the skateboard is off the ground when the skateboard is unloaded. When the skateboard is loaded, the leaf spring is deformed, making the rear wheel contact the ground. An advantage of the power accessory is that the skateboard has the same steering characteristics after installation of the power accessory. However, a simple steering mechanism easier to operate is desirable.

Known are in the art scooters comprising a user support platform, a front wheel, a support of the front wheel and suspension means. For example, U.S. Pat. No. 5,154,436A discloses a scooter having a board member on which a rider can stand. The scooter has a vertical shaft attached at one end of the board member. The vertical shaft is provided with a horizontal handle at the top thereof. The aim of the handle is to improve balance of the rider and can be used to effectuate jumps and other aerial maneuvers. In addition, the scooter comprises an arcuate leaf spring under the board member. The arcuate leaf spring is not attached to the board member but rather engages the board member when a downward force from the weight of the rider is applied. The principal function of the leaf spring is to provide a resilient deformation restoring force to the board member. In this way the scooter of U.S. Pat. No. 5,154,436A can be provided with a thinner, and hence more flexible, board member which can flex enhancing rider's control.

GB151691A discloses a motor driven scooter which comprises a footboard and a front wheel carried by front wheel fork. An up and down swingable member carries the front wheel fork and, at another section, the swingable member carries an active housing. One end of a spring is fixed to the active housing while the other end of the spring is fixed to a stationary housing. In this way, swinging of the swingable member causes swinging of the active housing and hence the spring changes its curvature. In this way, the spring springs the front wheel of the motor driven scooter.

However, a simple, small and compact steering mechanism easier to operate is desirable. In addition, it is desirable a scooter where it is decreased the degree to which the user feels bumps in the ground while driving the scooter. Simultaneously it is desirable to decrease the amount of space required by the suspension and, more particularly, by an impact absorber.

The disclosure further provides a steering transmission system for a scooter, which is simpler, lighter, and more versatile that the current steering systems based in a steering column.

### SUMMARY

For overcoming the state of the art limitations, the present disclosure proposes a scooter according to claim 1.

In the present description, an attempt has been made to use the terminology commonly used in mechanics. The median plane must be understood as a plane that divides the main body of the scooter into two equal parts, that is, it is a plane of symmetry of the scooter. It can also be defined as a plane containing the longitudinal direction of the scooter and a line perpendicular to the user's support platform. Another way of expressing it would be as a vertical plane that passes through the longitudinal direction when the scooter is in vertical arrangement. In any case, this medium plane has been represented in the figures to leave no doubt.

The definition of this plane is essential for the correct interpretation of the claimed subject matter. When reference is made in the description and in the claims that the impact absorbing is deformable or movable in said plane, it means that its degrees of freedom of movement are contained in that plane and that it can also rotate or deform in that plane, which It should be understood that the vector describing its rotation or the vectors defining its deformation is/are a vectors perpendicular to its plane. In other words, all points of the impact absorber move in planes parallel to said median plane. It does not at all mean, as the skilled person knows, that the impact absorbed is contained in the mentioned plane.

With respect to the front wheel support, the disclosure applies to any wheel support that allows carrying out the disclosure. In the most classic case this support can consist of a fork. In other embodiments it can be conceived that it is a single lateral arm, of the type that forms a U-piece, one of whose legs is the axis of the wheel. In more elaborate embodiments, it could be a substantially horizontal crown which is rotatable according to a rotation having a substantially vertical vector, the support supporting the wheel axle at two ends of said axle.

The characteristics of the disclosure allow making dynamically independent, in a region as close as desired to the wheel axis, the damping and steering functions. In particular, the disclosure allows the forces caused by the impacts to be brought along the shortest path to the platform and, on the other hand, allows the structural requirements of the steering elements to be drastically reduced.

In the state-of-the-art scooters, the suspension means are integral with the steering bar. That implies that the steering bar carries with it the suspension elements, which in most cases involve a large mass that is rotatable with the steering bar itself. One of the drawbacks is that the steering means are complex and forces the driving means, i.e. the user, to deal with the inertia of the suspension and damping components. In addition, the fact that the suspension elements rotate together with the wheel imply limitations in the design of its components, which involve both the elastic recovery element k and the damping c. Another drawback that is overcome is the complexity, and hence the lack of aesthetics of the prior art solutions. The present disclosure, by separating the functions, open a great variety of possibilities both for the steering of the wheel and for the suspension means.

The only limitation involved in the present disclosure is guaranteeing that the rotation of the front wheel support has the minimum friction with the impact absorber. As claimed, the main relative moment therebetween is the steering rotation movement, which can easily be dealt with bearings, which, considering the forces involved, can have a very reduced dimension.

As will be seen, by making independent the steering and suspension functions, different technologies can be used independently for both.

For the suspension, many solutions can be used.

In some embodiments, the impact absorber comprises two or more plates hinged therebetween, the plates being connected by articulations and elastic elements.

In other embodiments, the impact absorber comprises one or two parallel bars, which front ends support the front wheel axis and which rear ends are articulated with the platform according to an axis of rotation perpendicular to the median plane.

In other embodiments, the impact absorber is a single leaf spring. This is a very elegant solution due to its simplicity, and also due to its good aesthetics.

In other embodiments, the impact absorber can be composed of two laterally adjacent leaf springs.

In other embodiments, the impact absorber can be a stack of leaf springs, such that it can have damping properties too.

In cases where plates, bars or leaf springs are used, the impact absorber can be provided with recesses or through openings for the passage of fixing elements and/or structural components.

In some embodiments, the front end of the impact absorber is above the wheel such that the suspension means transmit the impacts to the platform through a region located just above the front wheel, the support of the front wheel bearing preferably on a lower surface of the impact absorber.

This a simple embodiment that allows to use the classical fork as front wheel support.

In other cases, the front end of the impact absorber is substantially at the level of the wheel axis. This is the case where the axis of the wheel is supported by a rotating crown.

In some embodiments, the scooter comprises steering means and a link between the support and the steering means.

As will be seen in the preferred embodiments, the steering can be implemented in a classical manner by means of a steering rod, although of variable length, for example by means of a telescopic coupling, or a flexible shaft.

Another way of implementing the steering is by means of an electric steering motor, arranged to drive the front wheel support, the rotation of this motor being controlled from the handlebar.

Another option is to use cables, either provided with forwarding or by using the well-known Bowden cables. This latter solution can be considered as an independent disclosure, since in spite of bringing synergies with the novel impact absorber, it can be applied in any scooter, even devoid of suspension means.

In some embodiments, the impact absorber extends backwards by means of a rear end, a rear wheel bearing on the rear end of the elongated element such that the impact absorber also constitutes the suspension of the rear wheel.

It is a solution that is very elegant from a mechanical and also aesthetic point of views, since a single slender element extending along the longitudinal direction of the scooter constitutes both the front and rear suspension means. This element replaces the usual mechanical elements implemented based on springs, cams, etc., which make known scooters little slender, to constitute an element whose function is not apparent.

In some embodiments, the steering means comprise a steering rod that can rotate with respect to the platform, the support passes through the impact absorber, such that the link between the support and the steering rod is placed over the impact absorber.

In some embodiments, the link between the support and the steering rod is mechanical and is telescopic such they are mutually linked according to a single degree of freedom.

In some embodiments, the platform has an upper prolongation that extends forwards and upwards, such that it encloses an upper portion of the steering rod, the link between the support and the steering rod being preferably inside the upper prolongation.

It is an elegant solution that allows to hide mechanical articulation elements, which is beneficial for safety, for the protection of the scooter's joints and also from a purely aesthetic point of view.

This upper prolongation can also serve as a cable concealment element when this is the option for the scooter's steering system.

In some embodiments, an articulation portion of the support located above the impact absorber and below the link between the support and the steering rod is articulated or is elastic such a that it allows bending the articulation portion in the plane defined by the steering rod and the longitudinal direction of the scooter.

It is an advantageous option that is largely viable thanks to the concept of independence between steering and suspension. By becoming independent, the steering bar is no longer subject to so many axial efforts, and therefore can be implemented with elements of reduced section, which in turn can be implemented with elastic parts.

In some embodiments, the articulation portion comprises a cardan articulation and/or elastic portion such that is bendable.

We emphasize that this solution constitutes an disclosure in itself, independent of the main concept claimed. In many state-of-the-art scooters, the folding of the steering column with respect to the user platform is achieved by a locking and unlocking system that implies a weak point in the direction. On the other hand, the use of elastic or cardan parts avoids having to make couplings and decoupling of the steering bar, thus avoiding the presence of weakened areas. Likewise, it is emphasized that this prevents parts that may be, throughout the use, source of mismatches, tolerances that are extended etc.

In some embodiments, the impact absorber is attached to the platform in a central area of the platform, the central area being preferably located in the second third of the platform.

As already pointed out above, a very advantageous effect of the disclosure is that the suspension means can be extended throughout virtually the entire scooter. That offers many possibilities for anchoring and joining, and also many possibilities for damping. For example, when anchoring or joining the impact absorber in a central area of the scooter, which could be for example an area that extends a considerable portion of the scooter, such as 20% of its total length, will achieve a very comfortable dynamics for the user, because the impact forces can be distributed much more than in the known scooters, where all the impacts are concentrated in the front area.

In some embodiments, the scooter comprises a rotating bearing for transmitting the forces between the support of the front wheel and the impact absorber.

Making steering and suspension independent implies, as claimed as an essential feature of the disclosure, that there must be a rotation between the impact absorber and the front wheel support. The union can be made directly, providing that the materials have minimal friction with each other, through the use of lubricants etc. Another possibility, taking into account that it is a point that will transmit high impact efforts is that it has bearings.

In some embodiments, the attachment between the platform and the elongated impact absorber comprises elastic parts, and is preferably formed by a transversal axis that allows the impact absorber to rotate with respect to the platform, and at least four pairs of elastic parts, preferably cylindrical or triangular, that elastically limit the rotation angle of the impact absorber with respect to the platform around said axis.

In this way, when subjected to certain impacts, the impact absorber can be rotated instead of be deformed, decreasing the stress to which the impact absorber is subjected.

In some embodiments, the impact absorber(s) is (are) made of plastic, metal, fiber material, carbon fiber, composite or wood.

Therefore, the impact absorber can be made of a broad range of materials and at the same time can have a broad range of geometries, while achieving the desired impact absorption.

It should be noted that the impact absorber is very advantageous with respect to spring-based suspensions. First, it allows a pleasant feeling to the driver and furthermore it is safer, since the impact to the platform, and hence to the user, is much more smooth and extended in time. With one part and without mechanisms consisting of many pieces, both suspensions are obtained, both the front and the rear. From an aesthetic point of view, it also provides advantages, since it can be designed so that it is slender, as opposed to systems based on springs and connecting rods, which always give a more technical and less aesthetic appearance. Another advantage is that it can be manufactured with lightweight materials, which replaces the components of the compact suspensions, which also involve inertia of rotation in the steering bar (spring based impact absorbers rotate together with the wheel).

In some embodiments, the scooter comprises a retractable handle in the rear portion or stern of the platform.

As this solution will be described, it also constitutes an disclosure in itself that could be implemented in many existing scooters. A known solution for having a scooter carrying handle is to provide a through opening in the platform. However, this solution is expensive, and implies weakening of the user platform, which is an important sacrifice when it comes to a purely auxiliary element. On the other hand, the retractable handle arranged in the stern of the scooter, in an area less structurally compromised, is very advantageous, since it does not affect the structure, it is easy to implement, and is hidden and symmetrical.

The disclosure also relates to a vehicle comprising a front wheel, a support of the front wheel, a steering handlebar, a platform and a front part joined to the platform, wherein that the support is rotatably mounted on the front part, the support comprising a driven rotating part, the handlebar comprising a driving rotating part, the driven rotating part and the driving rotating part being connected by Bowden Cables or by hydraulic tubes.

In some embodiments, the platform has an upper prolongation that extends forwards and upwards, the upper prolongation being articulated with respect to the platform, so that the prolongation can be folded over platform, the upper prolongation supporting the handlebar.

In some embodiments, the driven rotating part is a pulley or crown, connected to the support, the pulley or crown being linked to the handlebar with at least two Bowden cables, the driving rotating part containing a pulley or crown for pulling the cables.

In some embodiments, the steering transmission comprises two pairs of Bowden cables, such that two of the cables are rolled up in the pulley or crown in a direction, and the other two cables are rolled up in the pulley or crown in the opposite direction, such that the driving and driven pulleys or crowns are always subjected to a pair of opposite forces independently of the rotating sense.

In some embodiments, the driven rotating part is a first volumetric actuator linked to the handlebar, with at least two hydraulic tubes, the driving rotating part being a second volumetric actuator.

In some embodiments, the volumetric actuators comprise a volume generated by a constant section around a circular path, the handlebar being connected to a moving wall guided within the volume, such that two volumes of varying capacity are defined.

In some embodiments, the connections of the hydraulic tubes are perpendicular to the general plane of the circular path are perpendicular to the general plane of the circular path or form an angle lower than 30° with the direction perpendicular to the general plane.

In some embodiments, the front part comprises a rotating bearing for transmitting the forces between the support of the front part and the handlebar. Preferably, the vehicle is a scooter or an electric scooter.

In some embodiments, the front part of the scooter is the extreme of an impact absorber linked to the platform, the impact absorber comprising a front end, the impact absorber being movable or deformable only in a median plane of the platform such that the support of the front wheel is rotatable with respect to the impact absorber to allow steering of the scooter, the support of the front wheel leaning on the front end of the impact absorber, such that the suspension means transmit the impacts to the platform.

In some embodiments, the front end of the impact absorber is above the wheel such that the suspension means transmit the impacts to the platform through a region located just above the front wheel that extends backwards, the support of the front wheel bearing preferably on a lower surface of the impact absorber.

the impact absorber is:
two or more plates hinged therebetween, the plates being connected by articulations and elastic elements;
one or two parallel bars;
a single leaf spring;
two laterally adjacent leaf springs;
a stack of leaf springs;

the impact absorber being provided preferably with recesses or through openings for the passage of fixing elements and/or structural components, preferably the impact absorber is (are) made of plastic, metal, fiber material, carbon fiber, composite or wood, or a combination thereof.

In some embodiments, the impact absorber extends backwards by means of a rear end, a rear wheel bearing on the rear end of the elongated element, such that the impact absorber also constitutes the suspension of the rear wheel.

In some embodiments, the impact absorber is attached to the platform in a central area of the platform, the central area being preferably located in the second third of the platform.

The disclosure also relates to an impact absorber for a scooter provided with a support of the front wheel, formed by at least a leaf spring comprising a front end destined to bear the support of the front wheel, an opening adjacent to the front end destined to allow the passage of an upper prolongation of the scooter platform, and a rear end provided with two arms destined to support the rear wheel, such that the impact absorber constitutes the suspension of both the front wheel and the rear wheel.

Preferably the impact absorber is made of carbon fiber, composite materials, veneer wood, a stack of metal layers, or elastic materials.

Another disclosure also relates to a steering system by Bowden cables and pulleys or crowns, which comprises two pulleys or crowns, one joined to a handlebar and the other joined to the support of the front wheel, both connected by Bowden cables, wherein the pulley attached to the handlebar is connected to the end of one or more Bowden cables that are connected, in the other end, to the pulley or crown attached to the support of the front wheel, in such a way that the cables transmit the movement of the handlebar to the front wheel, and vice versa, preferably in a one to one relation.

Yet another disclosure relates to a steering system by Hydraulic transmission, which comprises a first volumetric actuator and a second symmetrical volumetric actuator, both connected by two hydraulic tubes, wherein the volumetric pump comprises a volume generated by a constant section around a circular path, a rotating driver being connected to two moving pistons guided within the volume of the first volumetric device, an output shaft being connected to the rotating driver and the support of the front wheel, in such a way that the hydraulic fluid travel between both pumps through the hydraulic tubes, provoking in the other volumetric pump a symmetrical process, transmitting without slippering nor delays the rotating movement of the handlebar to the front wheel, and vice versa, preferably in a one to one relation.

Finally, and preferably, the connections of the hydraulic tubes are perpendicular to the general plane of the circular paths or form an angle lower than 30° with the direction perpendicular to the general plane.

### BRIEF DESCRIPTION OF THE DRAWINGS

To complete the description and in order to provide fora better understanding of the disclosure, a set of drawings is provided. Said drawings form an integral part of the description and illustrate an embodiment of the disclosure, which should not be interpreted as restricting the scope of the disclosure, but just as an example of how the disclosure can be carried out. The drawings comprise the following figures:

FIG. 1 is a first perspective view of a scooter provided with an inventive impact absorber.

FIG. 2 is a second perspective view of a scooter provided with an inventive impact absorber.

FIG. 3 is a lateral view of the scooter of FIGS. 1 and 2.

FIG. 4 is a rear view of a scooter provided with an inventive impact absorber.

FIGS. 5, 6a and 6b are schematic lateral views showing different positions of an impact absorber with respect to a user support platform of a scooter.

FIGS. 7, 8 and 9 are schematic lateral views showing different positions of an impact absorber with respect to a user support platform showing attachments between the platform and the impact absorber.

FIG. 10 shows a schematic lateral view of an impact absorber attached to a user support platform of a scooter.

FIG. 11 shows a rear portion of a user support platform of a scooter according to an embodiment, provided with a retractable handle, in an occult position.

FIG. 12 shows a rear portion of a user support platform of a scooter according to an embodiment, provided with a retractable handle, in a use position.

FIG. 13 is a schematic lateral view of the lower front portion of a scooter according to an embodiment where the steering means comprise a steering rod having a bendable portion.

FIG. 14 is a top view of a scooter according to an embodiment of the disclosure which shows the median plane.

FIG. 15 shows a section of an embodiment of the mechanical link between the front wheel support and the front end of the impact absorber.

FIG. 16 is an elevation of the front portion of the scooter in an embodiment in which the steering means are based on a cable or hydraulic transmission.

FIG. 17 shows a complete elevation of an embodiment in which the transmission of the steering between handlebars and wheel support is done by inextensible cables.

FIG. 18 shows a detail of an embodiment in which a steering crown and at least two Bowden cables are used as steering means.

FIG. 19 is an exploded view of the handlebar and driving pulleys, with the ends of the cables.

FIG. 20 is a view of the driving pulley.

FIG. 21 is a detail of FIG. 19.

FIGS. 22 and 23 schematically show the connection of the four Bowden cables according to a preferred embodiment.

FIG. 24 shows an exploded view of a further disclosure relating to a hydraulic actuator.

FIG. 25 shows the same device as in FIG. 24, but with the handlebar, and hence the moving walls, in another configuration.

FIG. 26 shows another view of the volumes having a variable capacity, thanks to the moving walls.

FIG. 27 is an elevation view with a partial cross section of the actuator volumes.

FIG. 28 is a plan view of the hydraulic device, mounted.

FIG. 29 is a perspective view of the hydraulic device, mounted

FIGS. 30 and 31 are perspective views of an inventive impact absorber.

FIG. 32 is a lateral view of the impact absorber.

FIG. 33 is a plan view of the impact absorber.

FIG. 34 is a front view of the impact absorber.

FIG. 35 schematically shows the embodiment based on Bowden cables, especially the two ends, the wheel on the left and the handlebar on the right.

### DETAILED DESCRIPTION OF THE DRAWINGS

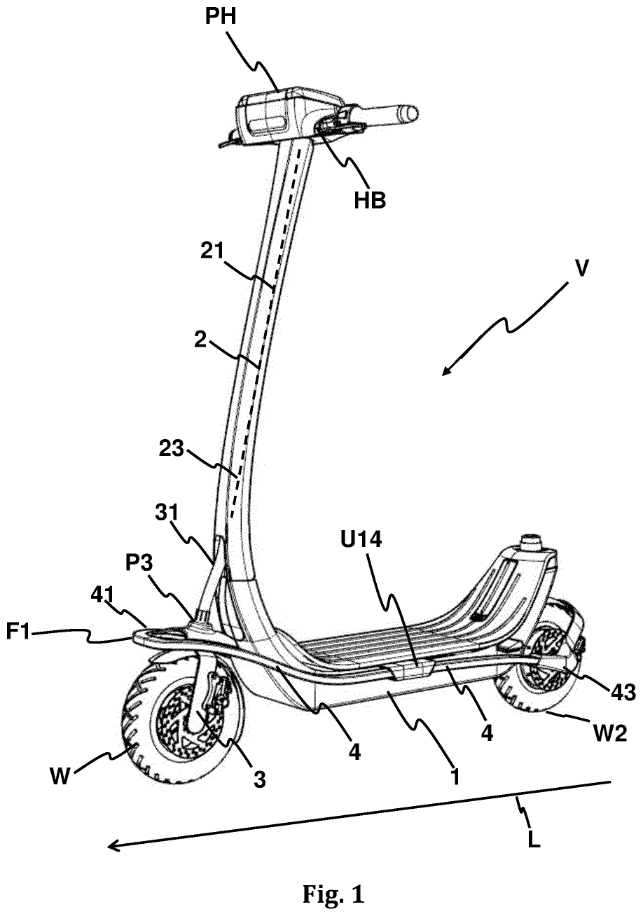

As shown in FIG. 1, according to an embodiment, the scooter V comprises a user support platform 1, a front wheel W and a support 3 of the front wheel W.

The scooter is provided with suspension means which comprise an impact absorber 4 linked to the platform 1.

The impact absorber 4 is a key component of the present disclosure, which main concept is based in making it independent of the steering means by allowing it only to move in the median plane MP. That is, the impact absorber of the disclosure does not rotate with the front wheel.

This is achieved by providing an impact absorber 4 comprising a front end 41, the impact absorber 4 being movable or deformable only in a median plane of the platform 1 such that the support 3 of the front wheel W is rotatable with respect to the impact absorber 4 to allow steering of the scooter, the support 3 of the front wheel W leaning on the front end 41 of the impact absorber 4, such that the suspension means S transmit the impacts to the platform.

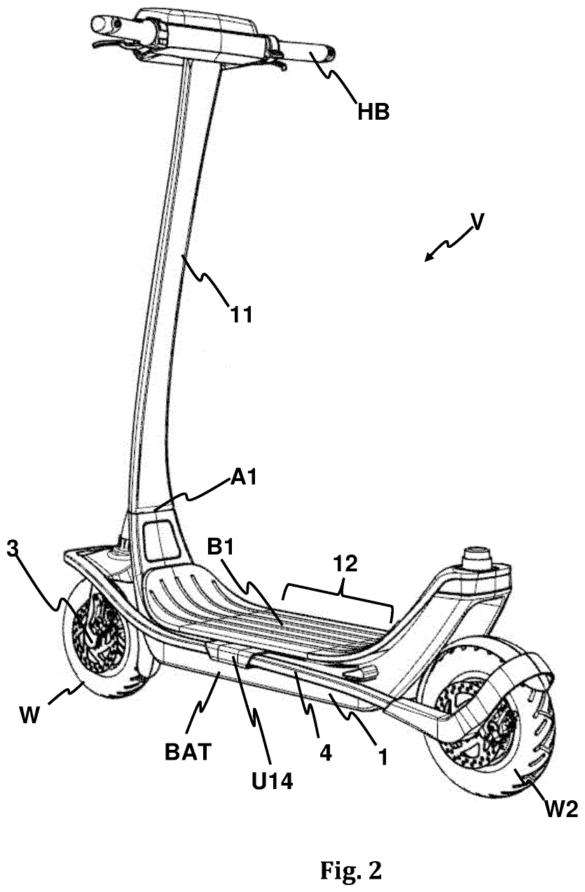

As can be seen in FIG. 2, an impact absorber 4 according to the disclosure can comprise two elongated elements, in this case two leaf springs 4, joined to the central part 12 of the platform 1, which meet at the bow to constitute a front end 41 on which the front wheel W support 3 leans on its lower face 42. Therefore, when the front wheel W receives an impact due to an irregularity of the terrain, the wheel support 3 will transmit the impact to the leaf spring 4, which will bend upwards, that is to say its movement will be in the plane of symmetry of the scooter V. Therefore, at the level of the region 41, the impact forces are already transmitted to the back of the leaf spring 4, to be transmitted to the platform by means of joining means U14 between platform 1 and leaf spring 4.

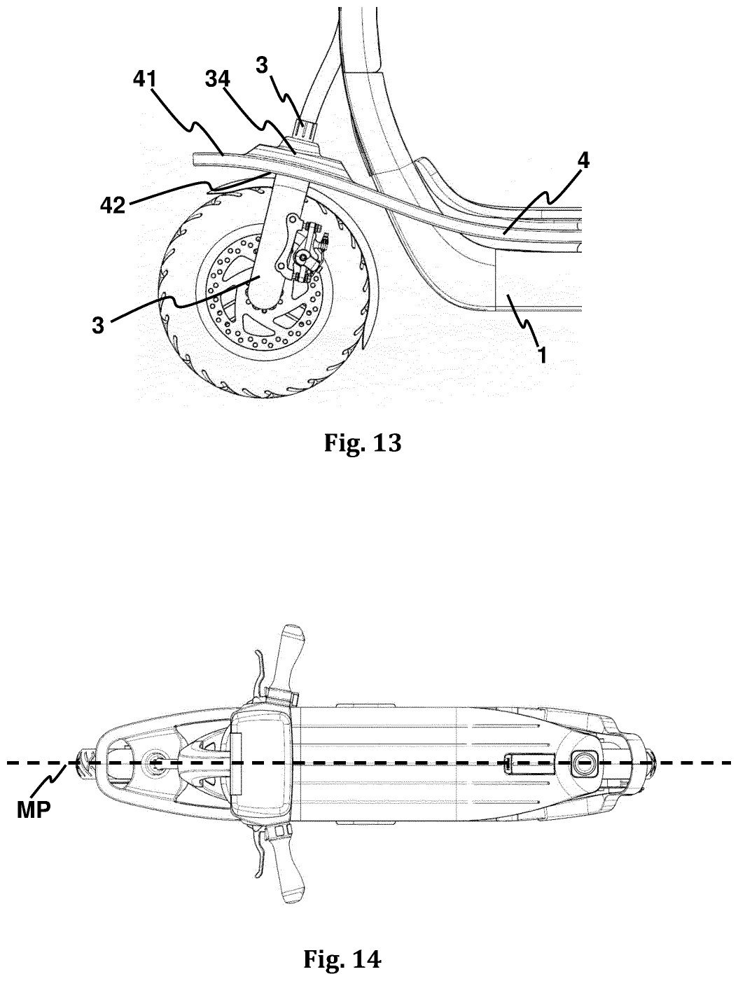

As shown in FIG. 1 or in FIG. 13, the front end 41 of the impact absorber 4 is above the wheel W such that the suspension means S transmit the impacts to the platform through a region located just above the front wheel W, the support 3 of the front wheel W bearing preferably on a lower surface 42 of the impact absorber 4.

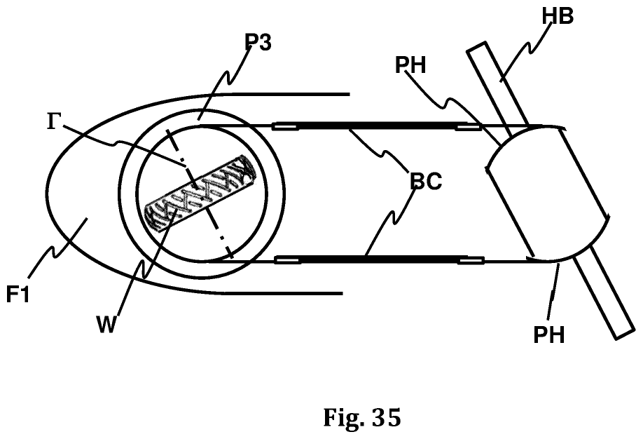

In another embodiment, like the one shown in FIG. 35, the support 3 of the wheel is a rotating crown 3 that supports the wheel axis F. The crown is embedded in the front end 41 of the impact absorber 4.

The embodiments shown are all based in a leaf spring 4. This leaf spring can consist, as mentioned, in two half-bodies that join in the bow 41, or front end.

Another possibility would be to implement the impact absorber as a leaf spring 4 like a unitary platform, that is to say in one piece, although provided with the necessary openings for the passage of joining elements between the lower platform elements BAT, where the battery could be housed, and the upper platform elements B1, where the user leans.

As shown in the figures, the scooter comprises steering means 2 and a link 23 between the support 3 and the steering means 2, the steering means 2 comprising preferably a steering rod 2 that can rotate with respect to the platform 1. In this case the support 3 passes through the impact absorber 4, such that the link 23 between the support 3 and the steering rod 2 is placed over the impact absorber 4. The link 23 between the support 3 and the steering rod 2 is mechanical and is telescopic (not shown) such they are mutually linked according to a single degree of freedom. Therefore, when an impact occurs and the support 3 moves upwards, its upper end moves axially inside a steering rod 2, which is integral with the steering handlebar Ha. This is the only degree of freedom allowed, as they cannot rotate relative to each other to ensure steering ability.

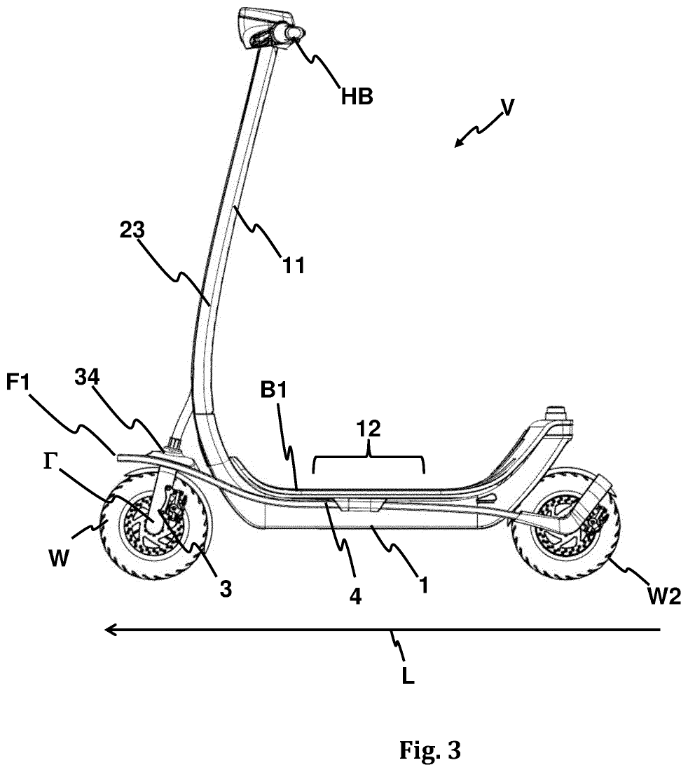

In the embodiments shown in FIGS. 1 to 3, the impact absorber 4 extends backwards by means of a rear end 43, a rear wheel W2 bearing on the rear end 43 of the elongated element 4, such that the impact absorber 4 also constitutes the suspension of the rear wheel W2. Preferably, the impact absorber has a shape comprising two inflexion points.

As already disclosed, the platform 1 has an upper prolongation 11 that extends forwards and upwards, such that it encloses an upper portion 21 of the steering rod 2, the link 23 between the support 3 and the steering rod 2 being preferably inside the upper prolongation 11.

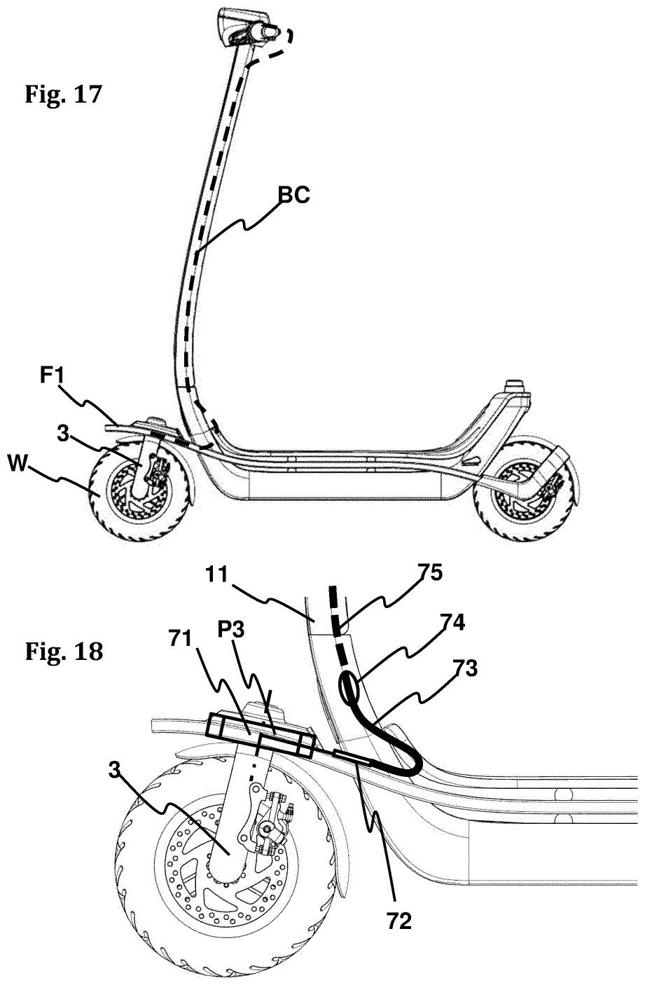

This upper prolongation 11 is a novelty in itself when applied to a scooter V. The disclosure allows the steering bar 2 to be smaller in size, which in turn allows said upper prolongation 11, which is integral with platform 1, also to be slender. Thus, it allows hiding steering elements, such as in this case the steering bar 2, or in other cases it could hide steering control cables BC (as those shown in FIGS. 17 to 19), Bowden type, electrical cables, or any auxiliary technical element. Therefore, it is not necessary that the purely technical elements have perfect finishes, since the upper prolongation 11 already performs the aesthetic function.

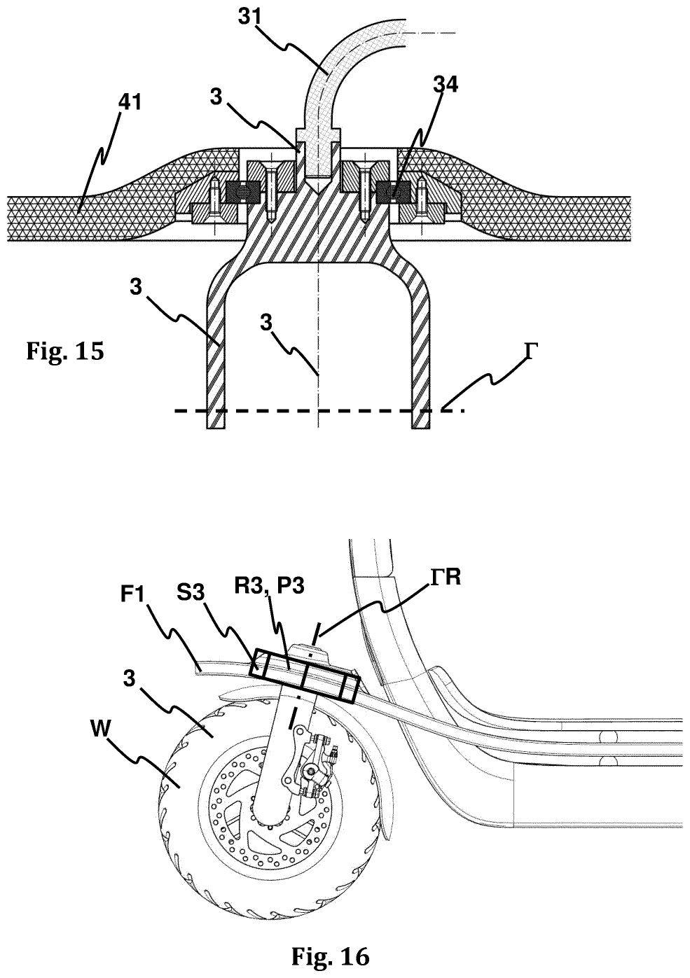

To allow folding the scooter V, according to a preferred embodiment, an articulation portion 31 of the support 3 located above the impact absorber 4 and below the link 23 between the support 3 and the steering rod 2 is articulated or is elastic such that it allows bending the articulation portion 31 in the plane defined by the steering rod and the longitudinal direction of the scooter V. This articulation portion 31 can comprise a cardan articulation and/or elastic portion 31 such that is bendable. FIG. 15 shows that a portion of the front wheel support 3 is bendable.

For reasons of clarity in the explanations, it has been considered that the part that can be folded 31 is part of the support 3. That has been done so, because between said part 31 and the wheel support there are no axial movements, as there are between the upper end of 31 and the steering bar 2, because to allow the absorption of the displacements caused by the impacts or by the bending of the steering column, it is necessary that there be, as it has been connected, a telescopic link.

As shown in the section of FIG. 15, the scooter comprises a rotating bearing 34 for transmitting the forces between the support 3 of the front wheel W and the impact absorber 4.

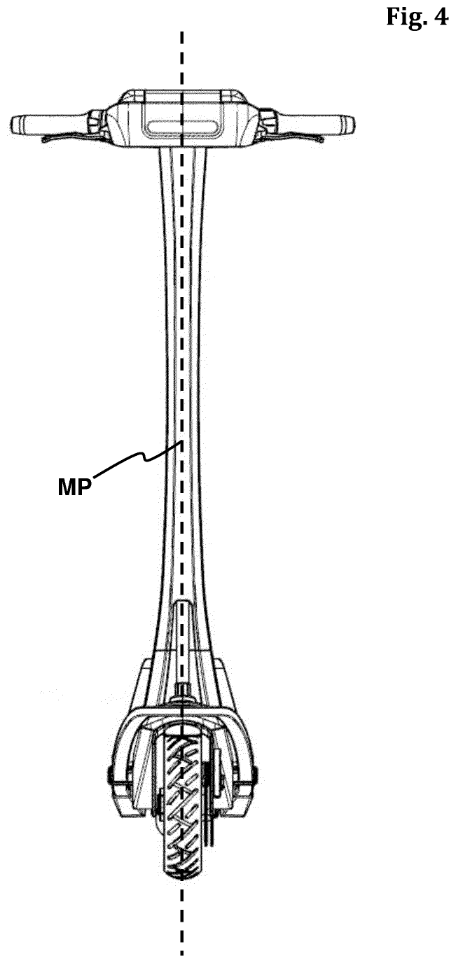

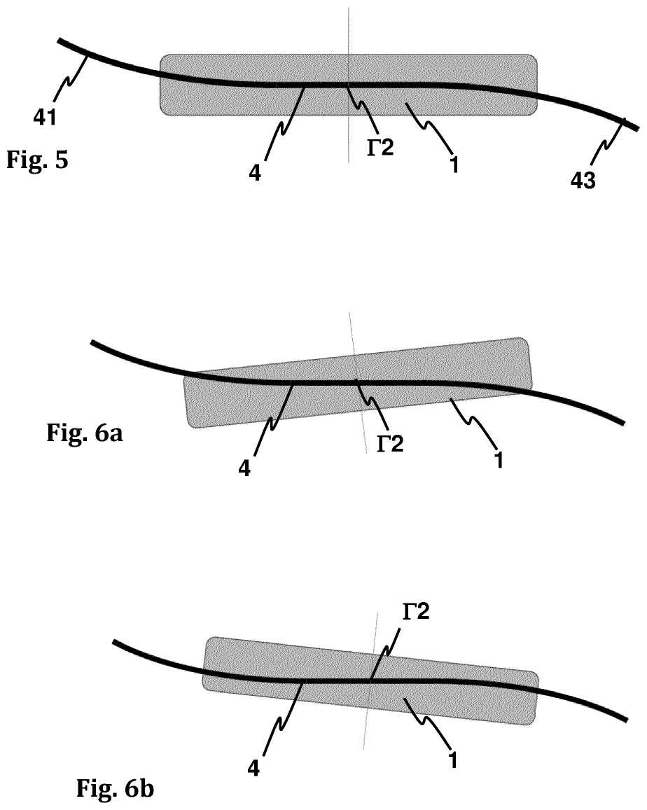

FIGS. 5, 6a and 6b illustrate one of the advantageous effects of the disclosure.

As mentioned, the disclosure allows the damping function to be carried towards the platform, including the union between impact absorber 4 and platform 1. This allows to create kinematics such as the one illustrated in the mentioned figures. In FIG. 5 a Γ2 articulation axis is highlighted. This axis Γ2 allows the relative movements illustrated in FIGS. 6a and 6b.

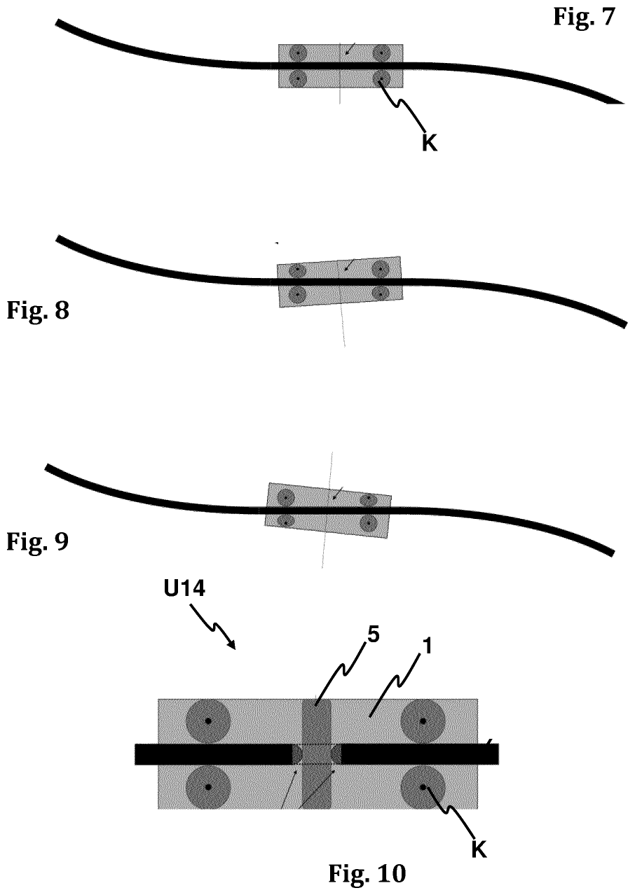

This axis illustrates roughly a kinematics sought between components 1 and 4. It can be implemented in many ways. For example with a physical axis that matches the axis Γ2. Another way of implementing it, which allows the joint area to be distributed in space, to distribute forces (and to reduce the requirements in terms of materials) is as illustrated in FIGS. 7 to 10, using elastic elements K.

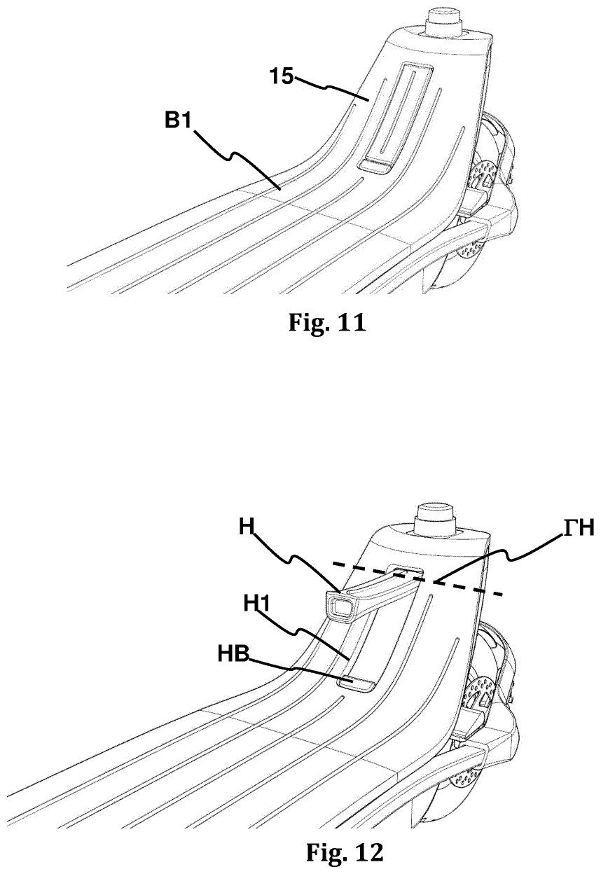

In FIGS. 11 and 12 an embodiment is shown in which the scooter preferably comprises, in an ascending slope section, a retractable handle H.

This particular feature comprises by itself an disclosure that could be claimed independently. The rear handle H of the platform is articulated with the platform by means of the axis FH, transverse to the scooter. A housing H1 is provided to hide the handle H. Also, an actuator or HB button can be provided that allows, by push, to release the handle so that it goes out to its use position.

Therefore, it is possible to claim a scooter V comprising a user platform 1, provided with an upper part B1, a rear end of said upper part B1 being provided with a housing H1, a rotating handle H articulated with said upper part B1 by means of a FH axis, so that the handle H can be moved between a position of use in which it is outside the housing H1, and another hidden position in which its upper part is flush with the upper surface of the upper part B1 of the platform 1. Preferably, a push-type release button HB can be provided that allows the handle H to be released, which can be deployed outwardly driven by a spring (not shown).

FIG. 16 shows an embodiment in which a steering rod 2 is dispensed with. In particular, in this embodiment, the steering components consist of an electric motor or electric actuator, in turn constituted by a stator S3 and a complementary rotor R3 that can rotate moved by stator S3. An advantage of the disclosure is that the impact absorber 4 has a shape and structure that allows to accommodate such a steering element. Then it will be provided that the handle has a user interface that allows it to remotely steer the wheel, which can rotate around the FR axis. In a particular embodiment, said user interface emulates a mechanical steering rod, for example it comprises movement sensors (e.g. accelerometers or gyroscopes) in a handle or a rod which can rotate but which does not mechanically transfer a steering movement to the front wheel W, instead the rotation is transferred electronically.

In another embodiment, illustrated by FIGS. 17 to 19, the steering means comprise Bowden BC cables. These are implemented, in a known manner by means of support bushes 72, a sheath 73 inside which is the traction cable. As can be seen, through an opening 74, a large part of the cable 75 can be hidden inside the upper extension 11.

The system is completed with an actuating crown 71, which acts as a lever between the ends of the two cables. It is a system known in the handling of boats, but which constitutes a novelty according to the present disclosure. And it stands out that what makes it especially easy to integrate a steering solution based on a rotary cable-operated support is the structure based on an impact absorber 4 that can only be moved in the mid-plane MP, as claimed.

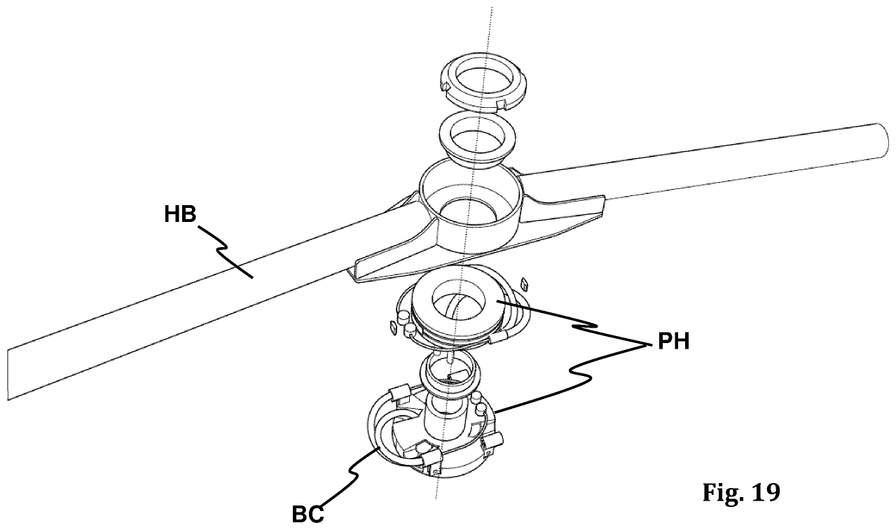

The operation of a cable-based steering system is shown in simplified form in FIG. 19. The handlebar HB is shown on the right, which has two associated pulley portions PH, where the ends of the BC drive cables are anchored. At the end of the wheel W there is a crown 3, to which the other ends of the cables are attached. If the effect is to be that of a classic steering bar, the radii of PH and 3 will be identical. Obviously, it could be conceived that there was a multiplier or multiplier effect by varying the ratio of radii.

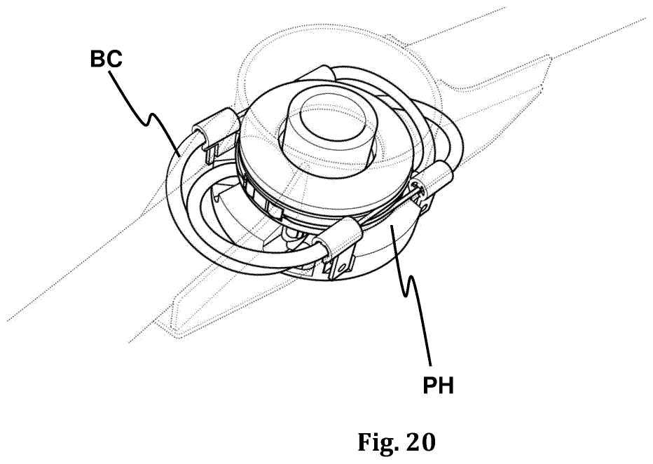

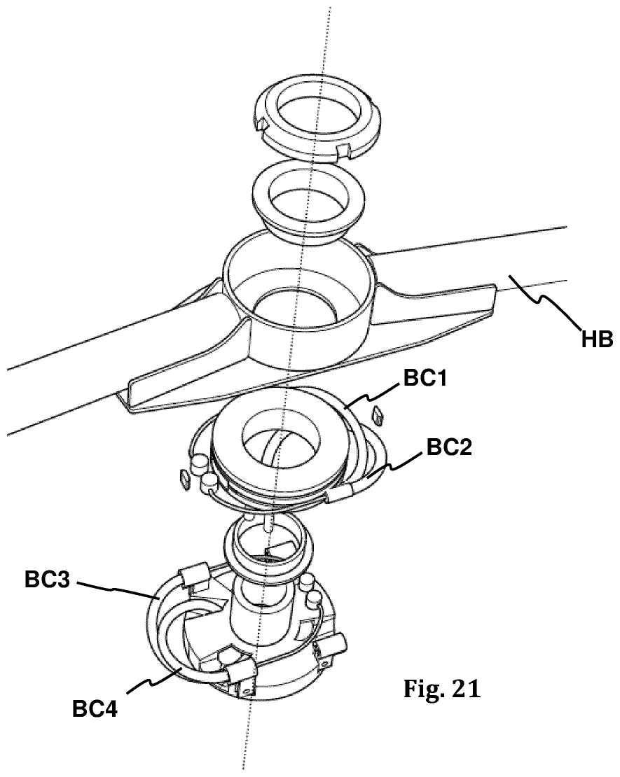

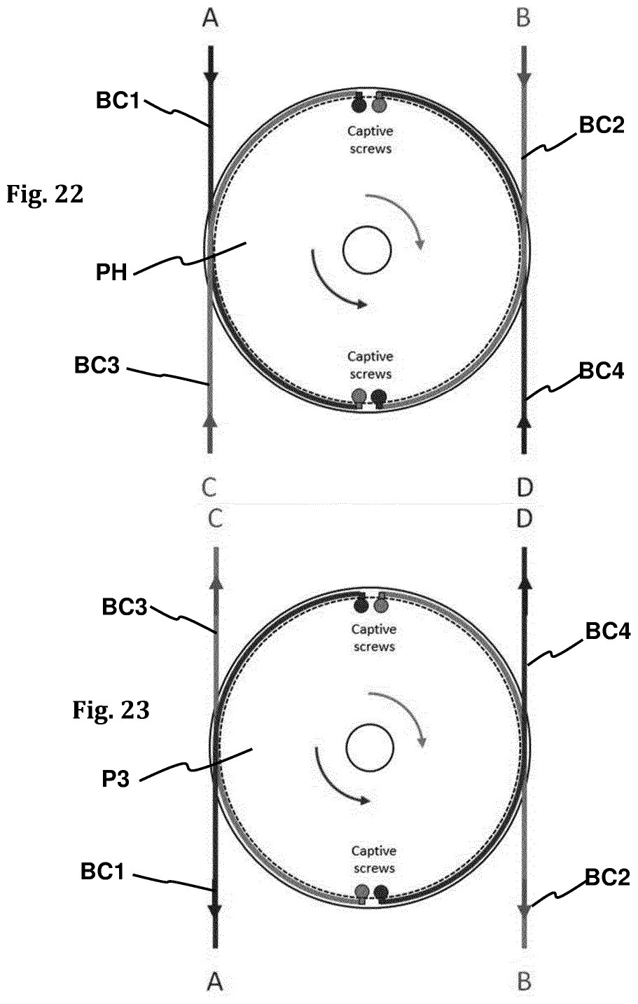

As shown in FIGS. 17 to 23, as an disclosure independent from the suspension means, herein also it is disclosed a Vehicle V comprising a front wheel W, a support 3 of the front wheel W, a steering handlebar HB, a platform 1 and a front part F1 joined to the platform 1, wherein the support 3 is rotatably mounted on the front part F1, the support 3 comprising a driven rotating part P3, the handlebar HB comprising a driving rotating part PH, the driven rotating part P3 and the driving rotating part PH being connected by Bowden Cables BC or by hydraulic tubes HT.

This solution allows to dispense with a steering rod, and specially makes easier the design of the folding of the upper prolongation 11 of the platform that extends forwards and upward and that supports the handlebar HB.

As shown, the driven rotating part P3 is a pulley or crown, connected to the support 3, the pulley or crown being linked to the handlebar HB with at least two Bowden cables BC, 71, 72, 73, 74, 75, BC1, BC2, BC3, BC4, the driving rotating part PH containing a pulley or crown for pulling the cables BC, 71, 72, 73, 74, 75, BC1, BC2, BC3, BC4.

In the preferred embodiment, there are two cables for transmitting the moment between the driving part and the driven part. In this way the pulleys are well balanced. In particular, the transmission system comprises two pairs of Bowden cables BC, 71, 72, 73, 74, 75, BC1, BC2, BC3, BC4, such that two of the cables BC1, BC4 are rolled up in the pulley or crown P3, PH in a direction, and the other two cables BC2, BC3 are rolled up in the pulley or crown P3, PH in the opposite direction, such that the driving PH and driven P3 pulleys or crowns are always subjected to a pair of opposite forces independently of the rotating sense.

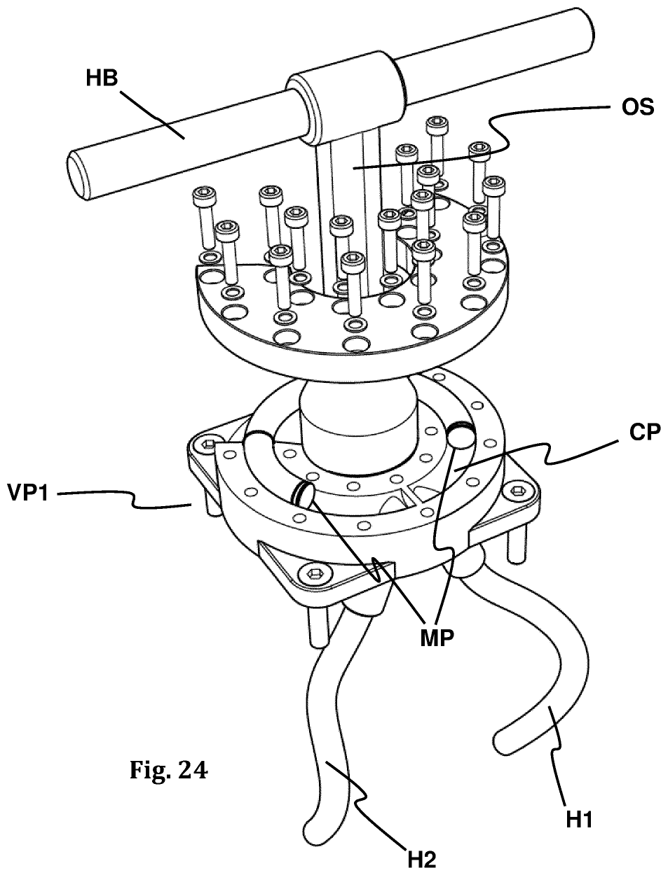

Another possibility is to implement the transmission system with hydraulic components. The system is analogous to the system based on Bowden cables just described. In particular, as shown in FIG. 24, the driven rotating part P3 is a first volumetric actuator VP1 linked to the handlebar HB, with at least two hydraulic tubes H1, H2, the driving rotating part PH being a second volumetric actuator. In a preferred embodiment, the driving and the driven parts are twins, such that the angles coincide. However, it can be conceived, like in the system based on cables, that the raddi are different, and therefore there is no more 1 to 1 relation.

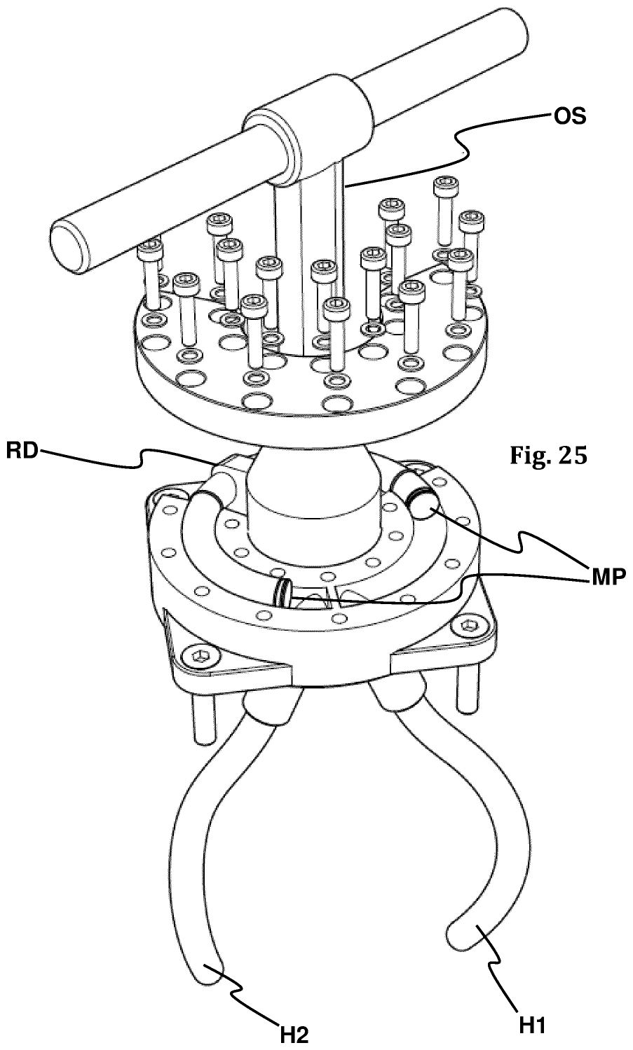

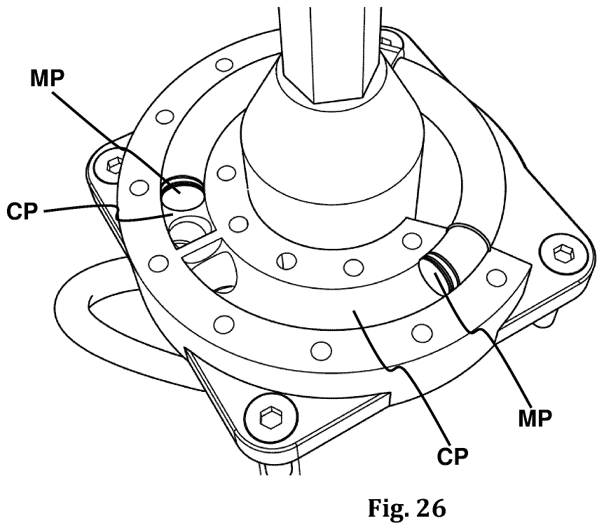

FIGS. 24 to 26 shows the working principle of the hydraulic transmission. In particular, it comprises a volume CP generated by a constant section around a circular path, the handlebar HB being connected to a moving wall MP guided within the volume CP, such that two volumes of varying capacity are defined. Obviously, as it is the case in all volumetric devices, the tightness of the joints has to be ensured.

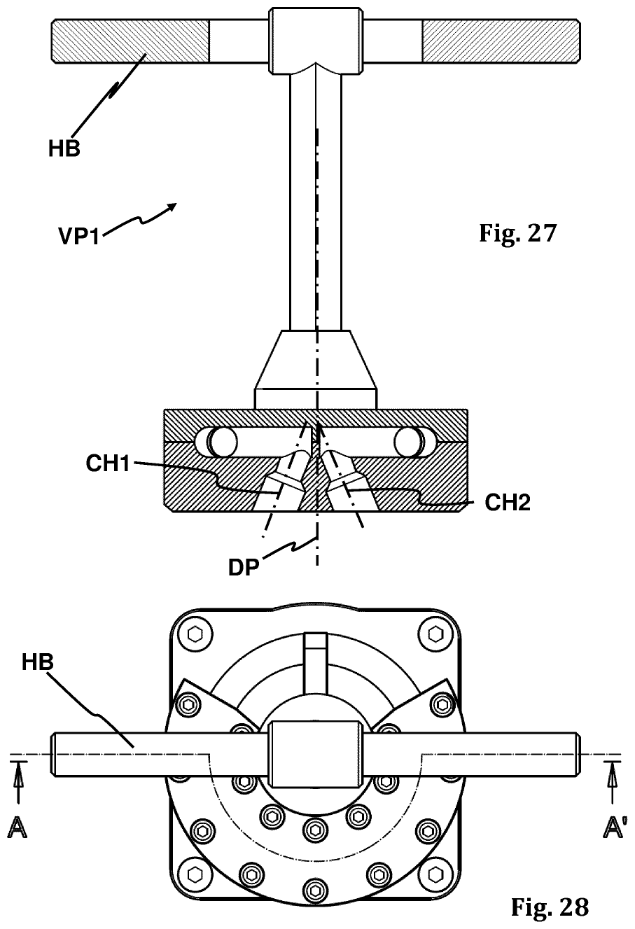

As shown in FIG. 27, the connections CH1, CH2 of the hydraulic tubes H1, H2 are perpendicular to the general plane of the circular path are perpendicular to the general plane of the circular path or form an angle lower than 30° with the direction DP perpendicular to the general plane.

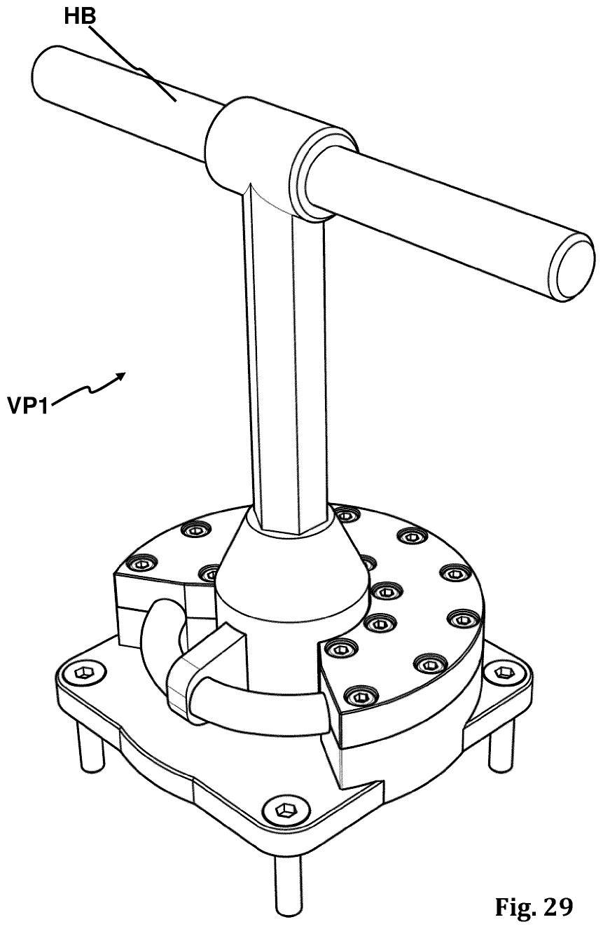

We point out that the transmission system shown in FIGS. 24 to 29 can be claimed as a separate disclosure, not necessarily in the context of a vehicle or a scooter. In the latter case, the transmission system should have small dimensions. It is a solution that fits specially when a highly accurate steering system is sought. Other fields where this hydraulic can be applied is in fluid installations, for example for remotely actuating valves.

Among the multiple possible suspension systems applied to the scooter that is object of this description, based on the concept of leaf spring—two side leaf springs, single or multiple, or a single central leaf spring—the latter has been chosen.

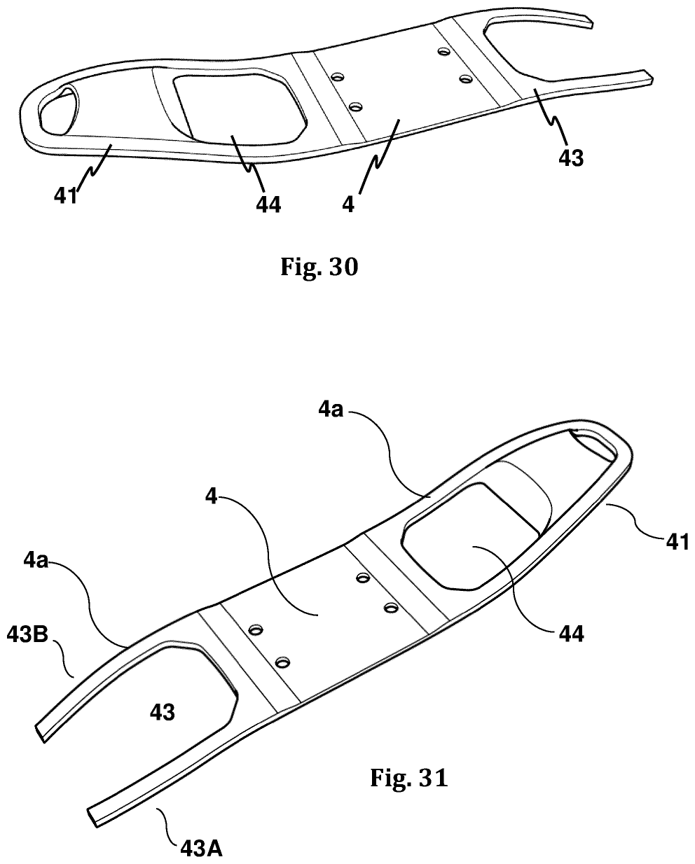

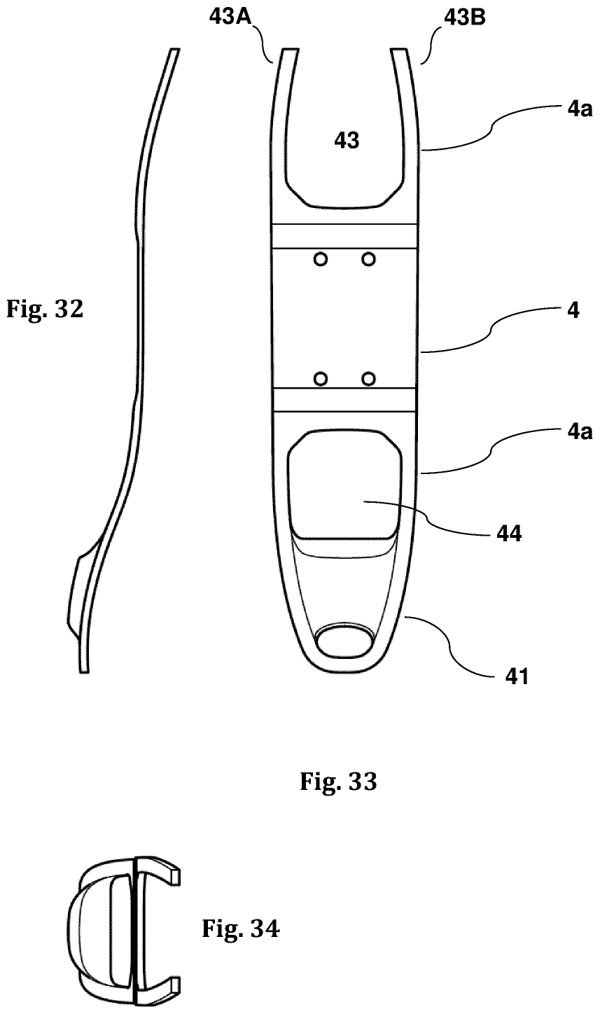

As shown in FIGS. 30 to 34, the impact absorber 4 for a scooter is provided with a support 3 of the front wheel W, which is formed by at least a leaf spring comprising a front end 41 destined to bear the support 3 of the front wheel W, an opening 44 adjacent to the front end 41 destined to allow the passage of an upper prolongation 11 of the scooter platform 1, and a rear end 43 provided with two arms 43A, 43B destined to support the rear wheel W2, such that the impact absorber 4 constitutes the suspension of both the front wheel W and the rear wheel W2.

It is a piece made of carbon fiber, or another elastic material, resistant to fatigue, with a high degree of resilience, including veneer wood or types of high resilience wood.

The material chosen, but not limited to it, has been carbon fiber. The whole piece is manufactured in multiple layers of this material, by means of a calculated combination of the direction of the fibers to achieve high levels of elasticity and resilience in the longitudinal plane, while controlling the torsion and elasticity by zones, using different thickness.

The intermediate zone 4 covers in width, approximately, that of the scooter, and, for it, thicknesses and direction of the fibers have been selected, such that the elastic deformation is contained in a reduced volume. This is necessary, since this intermediate zone is in which the scooter is held and supported. In it, holes are provided to securely hold the elevated structure of the scooter (steering column, handlebar, floor, electronic equipment box and rear area).

The front zone is composed of two subzones: an elastic subzone 4a, and another rigid subzone 41. The elastic subzone 4a, formed by two side bars, is calculated to withstand high deformations in the longitudinal direction of the scooter, with full and rapid recovery, with damping, against bumps and irregularities of the terrain. Subzone 41 can house, at its bottom, the steering mechanisms of the front wheel, using Bowden cables that moves a pulley, or a hydraulic actuator, controlled from the handlebar with another symmetrical actuator. The irregularities of the terrain, or impacts, are transmitted to the front wheel, where the subzone 41 is located, and, hence, the energy of the impacts is absorbed and returned with damping through the subzone 4a.

The rear zone 43 consists of two side bars, 43a and 43b, that extend backwards, at the end of which the rear wheel of the scooter is connected. These two bars, like those of subzone 4a, are highly elastic, with complete and rapid recovery, with damping. The irregularities of the terrain, or impacts, are transmitted to the rear wheel, where the two bars of zone 43 are supported, and, hence, the energy of the impacts is absorbed and returned with damping through the zone 43.

Zone 4 is not rigid, but it is calculated to transmit elastic energy from the front to the back, and vice versa. In this way, the entire piece, from back to front, actively intervenes in the suspension. Both the thicknesses of the fiber layers, as well as the fiber orientations, have been calculated to obtain the desired behavior.

In this text, the term “comprises” and its derivations (such as “comprising”, etc.) should not be understood in an excluding sense, that is, these terms should not be interpreted as excluding the possibility that what is described and defined may include further elements, steps, etc.

The disclosure is obviously not limited to the specific embodiment(s) described herein, but also encompasses any variations that may be considered by any person skilled in the art (for example, as regards the choice of materials, dimensions, components, configuration, etc.), within the general scope of the disclosure as defined in the claims.

1. A scooter comprising: a front wheel, a support of the front wheel, a steering handlebar, a platform and a front part joined to the platform, wherein the support is rotatably mounted on the front part, the support comprising a driven rotating part, the handlebar comprising a driving rotating part, the driven rotating part and the driving rotating part being connected by Bowden Cables or by hydraulic tubes, and wherein the front part is the extreme of an impact absorber linked to the platform, the impact absorber comprising a front end, the impact absorber being movable or deformable only in a median plane of the platform such that the support of the front wheel is rotatable with respect to the impact absorber to allow steering of the scooter, the support of the front wheel leaning on the front end of the impact absorber, such that the suspension means transmit the impacts to the platform.

2. The scooter according to claim 1, wherein the platform has an upper prolongation that extends forwards and upwards, the upper prolongation being articulated with respect to the platform, so that the prolongation is configured to be folded over the platform, the upper prolongation supporting the handlebar.

3. The scooter according to claim 1, wherein the driven rotating part is a pulley or a crown, connected to the support, the pulley or the crown being linked to the handlebar with at least two Bowden cables, the driving rotating part containing the pulley or the crown configured for pulling the Bowden cables.

4. The scooter according to claim 3, which comprises two pairs of Bowden cables, such that two of the Bowden cables are rolled up in the pulley or crown in a first direction, and the other two Bowden cables are rolled up in the pulley or the crown in a second direction opposite the first direction, such that the driving and driven pulleys or crowns are always subjected to a pair of opposite forces independently of the rotating sense.

5. The scooter according to claim 1, wherein the driven rotating part is a first volumetric actuator linked to the handlebar, with at least two hydraulic tubes, the driving rotating part being a second volumetric actuator.

6. The scooter according to claim 5, wherein the volumetric actuators comprise a volume generated by a constant section around a circular path, the handlebar being connected to a moving wall guided within the volume, such that two volumes of varying capacity are defined.

7. The scooter according to claim 6, wherein the connections of the hydraulic tubes are perpendicular to the general plane of the circular path are perpendicular to the general plane of the circular path or form an angle lower than 300 with the direction perpendicular to the general plane.

8. (canceled)

9. The scooter according to claim 1, the vehicle being an electric scooter.

10. (canceled)

11. The scooter according to claim 10, wherein the front end of the impact absorber is above the wheel such that the suspension means transmit the impacts to the platform through a region located above the front wheel that extends backwards, the support of the front wheel bearing on a lower surface of the impact absorber.

12. The scooter according to claim 9, wherein the impact absorber is:
two or more plates hinged therebetween, the plates being connected by articulations and elastic elements;
one or two parallel bars;
a single leaf spring;
two laterally adjacent leaf springs; and
a stack of leaf springs;
the impact absorber being provided with recesses or through openings for the passage of fixing elements and/or structural components, wherein the impact absorber is made of plastic, metal, fiber material, carbon fiber, composite or wood, or a combination thereof.

13. The scooter according to claim 1, wherein the impact absorber extends backwards by a rear end, a rear wheel bearing on the rear end of the elongated element, such that the impact absorber also constitutes the suspension of the rear wheel.

14. The scooter according to claim 1, wherein the impact absorber is attached to the platform in a central area of the platform, the central area being located in the second third of the platform.

15.-20. (canceled)
